(19) United States
(12) Patent Application Publication
(10) Pub. No.: US 2007/0053396 A1
(43) Pub. Date: Mar. 8, 2007

(54) Semiconductor lasers utilizing AlGaAsP

(75) Inventors: Mark Andrew DeVito, Vancouver, WA (US); Paul Andrew Crump, Portland, OR (US); Jun Wang, Vancouver, WA (US); Weimin Dong, Vancouver, WA (US); Michael Peter Grimshaw, Vancouver, WA (US)

Correspondence Address: PATENT LAW OFFICE OF DAVID G. BECK, P. O. BOX 1146, MILL VALLEY, CA, 94942, US

(73) Assignee: nLight Photonics Corporation, Vancouver, WA (US)

(21) Appl. No.: 11/212,420

(22) Filed: Aug. 24, 2005

(51) Int. Cl. H01S 3/14

(52) U.S. Cl. 372/39

(57) ABSTRACT

A means of controlling the stress in a laser diode structure through the use of AlGaAsP is provided. Depending upon the amount of phosphorous in the material, it can be used to either match the lattice constant of GaAs, thus forming a strainless structure, or mismatch the lattice constant of GaAs, thereby adding tensile stress to the structure. Tensile stress can be used to mitigate the compressive stress due to material mismatches within the structure (e.g., a highly strained compressive quantum well), or due to the heat sink bonding procedure.

### REFERENCE TO GOVERNMENT CONTRACT

This invention was made with U.S. Government support under Grant No. MDA972-03-C-0101 awarded by DARPA. The United States Government has certain rights in this invention.

### FIELD OF THE INVENTION

The present invention relates generally to semiconductor lasers and, more particularly, to a laser design and fabrication method for controlling stress in a diode laser.

### BACKGROUND OF THE INVENTION

High power diode lasers have been widely used in industrial, graphics, medical and defense applications. Power level, reliability, operating wavelength and electrical to optical conversion efficiency are the most important parameters for these lasers.

A typical laser diode has a certain amount of strain built into the structure, the strain due both from the selected manufacturing process (e.g., selected deposition technique and associated parameters) and from lattice mismatch between materials. FIG. 1 graphically illustrates the relationship between the lattice constant, i.e., atomic spacing, and the emission wavelength/bandgap for a variety of compound semiconductor materials. Area 101 highlights the materials typically used in the design of high power lasers. Assuming the use of GaAs as the substrate, the use of semiconductors on the left side of line 103 (e.g., GaP, AlP, etc.) will result in a tensile strain within the as-grown material while semiconductors on the right side of line 103 (e.g., InP, GaSb, InAs, etc.) will result in a compressive strain within the as-grown material.

In some instances a material may be purposefully strained during growth in order to control a particular quality of the final device, for example the emission wavelength. Typically in this case the material that is strained is part of the light producing region of the structure (e.g., quantum well) and is therefore very thin, on the order of 10 nanometers. Due to the thickness of the region, the strain within the region has little effect on the overall structure. In contrast, stress within the bulk materials that comprise the majority of a diode structure can have a significant effect on the overall structure. For example, the deposition of a 3.5 micron layer of AlGaAs on a 1 centimeter wide, 1 millimeter long, 140 micron thick GaAs substrate will impart sufficient compressive stress to the material to cause a curvature of approximately 4 microns.

The curvature which results from the deposition of thick layers of lattice mismatched material is a significant problem for laser diodes as they must typically be bonded to a heat sink in order to be able to operate at the power levels and durations required for commercial applications. As the bonding process requires the diode laser to be flat, if it is not, for example due to the curvature imparted by a mismatched deposited layer, the flattening process will introduce a stress field into the diode laser bar. Furthermore, since the bonding process is performed at a temperature greater than 140° C., differences between the thermal expansion coefficient of the heat sink and that of the laser diode bar cause an additional stress to be imparted to the laser diode during cooling.

The stress fields resulting from the flattening and high temperature bonding processes lead to non-uniform, poor performance in the finished laser diode. Typically this poor performance is manifested in regions of low light intensity and of mixed polarization. Accordingly it is clearly advantageous to eliminate, or at least reduce, these induced stress fields.

In some instances, a bulk layer material can be selected which, in combination with the selected substrate, does not suffer from the above-noted stress fields. For example, assuming a bulk layer of InGaAsP deposited on GaAs, there is a wide range of available band-gaps and lattice constants (see region 201 of FIG. 2). As such, for many desired wavelengths it is possible to select a composition for a bulk layer of InGaAsP which will result in a flat laser diode bar. Alternately it is possible to pick an InGaAsP composition that places the laser diode bar under tensile strain, thus mitigating the stress imparted by the bonding process. Unfortunately not every desirable bulk material allows such latitude in selection. For example, although laser diode structures fabricated with bulk layers of AlGaAs have been shown to provide high performance in terms of voltage, this material is naturally slightly compressive when grown on a GaAs substrate. Thus with this combination of materials, the device designer is not given a choice in material stress and thus can not design a device that limits the impact of the bonding stress on the diode bar performance (see line 301 of FIG. 3).

Accordingly, what is needed in the art is a design and fabrication process that can be used to achieve the benefits of an AlGaAs/GaAs laser diode structure without incurring the poor performance that results from the stress fields associated with the flattening and high temperature bonding processes. The present invention provides such a design and fabrication process.

### SUMMARY OF THE INVENTION

The present invention provides a means of controlling the stress in a laser diode structure through the use of AlGaAsP. Depending upon the amount of phosphorous in the material, it can be used to either match the lattice constant of GaAs, thus forming a strainless structure, or mismatch the lattice constant of GaAs, thereby adding tensile stress to the structure. Tensile stress can be used to mitigate the compressive stress due to material mismatches within the structure (e.g., a highly strained compressive quantum well), or due to the heat sink bonding procedure. The stress controlled laser diode structure of the invention can be a broad area laser, linear array laser, single spatial mode laser, single longitudinal mode laser or a surface emitting laser. The materials and structures of the invention can be grown using MOCVD, MBE, LPE or VPE.

One embodiment of the invention is a semiconductor diode laser comprising a GaAs substrate, a first cladding layer, a first confinement layer, a quantum well region, a second confinement layer, a second cladding layer and a contact layer, wherein at least one of the cladding layers and/or one of the confinement layers is comprised of AlGaAsP. The phosphorous content of the AlGaAsP layer is either selected such that the lattice constants of the substrate and the AlGaAsP layer match or mismatch. In the later case, the lattice mismatch can either be used to generate a tensile stress within the diode structure, or provide stress relief to the diode structure. The cladding layers, confinement layers, and quantum well region can be comprised of single or multiple layers. A buffer layer can be interposed between the GaAs substrate and the first cladding layer. Transition layers can be interposed between the substrate and cladding layer, buffer layer and cladding layer, and/or between either or both of the cladding layers and the confinement layers. Graded index layers can be interposed between either or both of the confinement layers and the quantum well region. The quantum well region can include barrier layers adjacent to the quantum well.

Another embodiment of the invention is a method for controlling the stress within a laser diode structure. The method includes the steps of selecting GaAs as the device's substrate, growing a first cladding region on the GaAs substrate, growing a first confinement region on the first cladding region, growing a quantum well region on the first confinement region, growing a second confinement region on the quantum well region, growing a second cladding layer on the second confinement region, growing a contact layer on the second cladding layer, and selecting at least one of the cladding regions and/or one of the confinement regions to be comprised of AlGaAsP. The composition of the AlGaAsP region can be selected to generate a tensile stress within the semiconductor diode laser to mitigate a compressive stress resulting from bonding the semiconductor diode laser to a heat sink; selected to generate a tensile stress to mitigate a compressive stress within the semiconductor diode laser structure; or selected such that the phosphorous content is greater than 4%.

In another embodiment of the invention, a method of controlling the stress within a semiconductor diode laser is provided, the method including the steps of selecting a substrate for the device, growing a first cladding region on the substrate, growing a first confinement region on the first cladding region, growing a first barrier layer on the first confinement region, growing a quantum well on the first barrier layer, growing a second barrier layer on the quantum well, growing a second confinement region on the second barrier layer, growing a second cladding region on the second confinement region, and growing a contact region on the second cladding region, wherein at least one of the barrier layers is comprised of GaAs and the adjacent confinement region is comprised of AlGaAsP.

A further understanding of the nature and advantages of the present invention may be realized by reference to the remaining portions of the specification and the drawings.

### BRIEF DESCRIPTION OF THE DRAWINGS

FIG. 1 illustrates the relationship between the lattice constant and the emission wavelength/bandgap for a variety of compound semiconductor materials commonly used in the fabrication of semiconductor lasers;

FIG. 2 illustrates the range of lattice constants and bandgaps available for a bulk layer of InGaAsP grown on GaAs;

FIG. 3 illustrates the range of lattice constants and bandgaps available for a bulk layer of AlGaAs grown on GaAs;

FIG. 4 illustrates the range of lattice constants and bandgaps available for a bulk layer of AlGaAsP grown on GaAs;

FIG. 5 illustrates the polarization map for a diode laser bar using a bulk layer of AlGaAsP;

FIG. 6 illustrates the polarization map for a diode laser bar using a bulk layer of AlGaAs;

FIG. 7 illustrates the intensity map for a diode laser bar using a bulk layer of AlGaAsP;

FIG. 8 illustrates the intensity map for a diode laser bar using a bulk layer of AlGaAs;

FIG. 9 illustrates the achievable output power for a diode laser bar using a bulk layer of AlGaAsP versus the achievable output power for a diode laser bar using a bulk layer of AlGaAs;

FIG. 10 illustrates the efficiency curve for a diode laser bar using a bulk layer of AlGaAsP versus the efficiency curve for a diode laser bar using a bulk layer of AlGaAs;

FIG. 11 illustrates the phase diagram for AlGaAsP on a GaAs substrate; and

FIG. 12 is an illustration of an exemplary epitaxial structure fabricated in accordance with the invention.

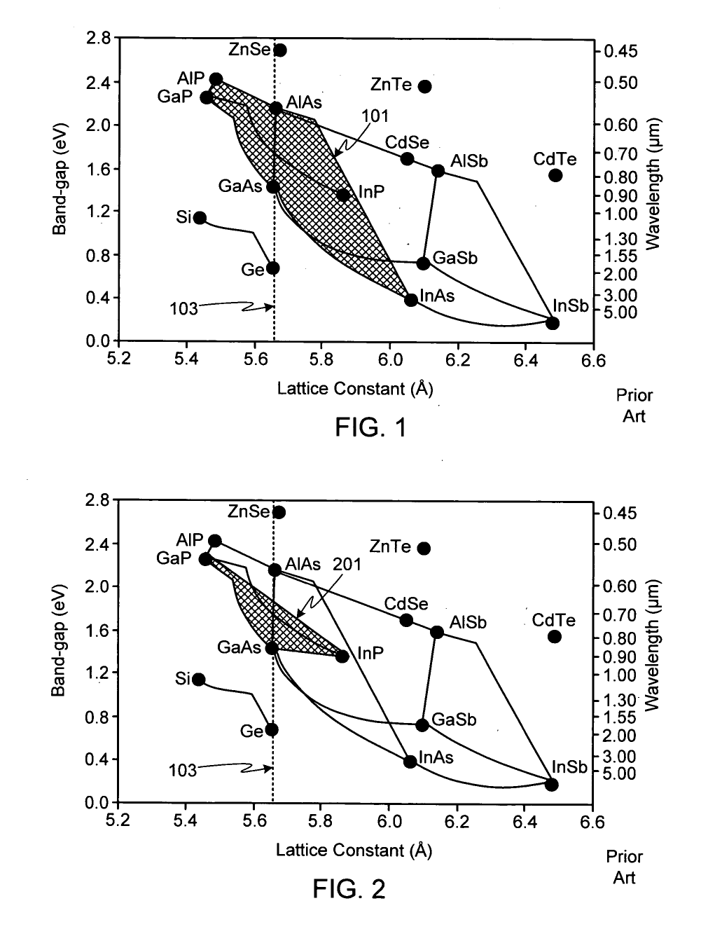

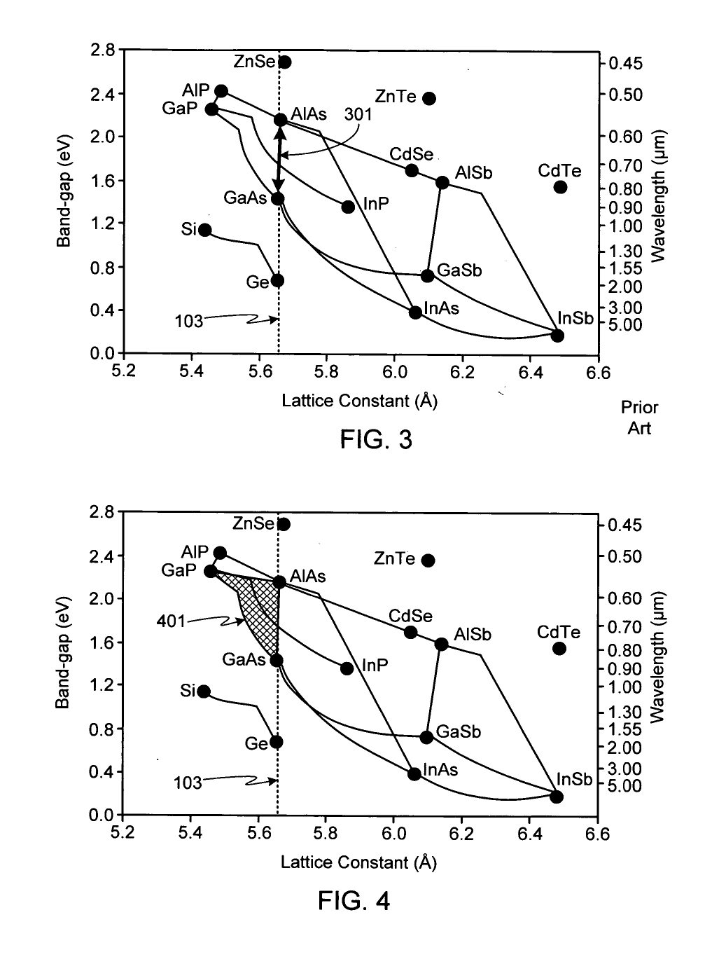

### DESCRIPTION OF THE SPECIFIC EMBODIMENTS

In order to overcome the afore-described problems, the present inventors have realized that the inclusion of small amounts of phosphorous in AlGaAs allow the lattice constant of the new material to be varied such that the stress field within a structure containing the AlGaAsP layer can be controlled. As a result, bulk layers of AlGaAsP, preferably with a thickness greater than 0.1 microns and more preferably with a thickness greater than 0.2 microns, can be grown directly on GaAs or placed elsewhere within the structure in order to achieve an overall structure that is either flat or under a tensile stress, the later condition providing a means of minimizing or eliminating the effects of the heat sink bonding procedure. FIG. 4 illustrates the range of available band-gaps and lattice constants (i.e., region 401) for AlGaAsP relative to GaAs.

As shown in FIG. 4, there is a range of available lattice constants, thus allowing either flat structures to be fabricated or, as preferred, device designs that compensate for stress fields either within the structure or that result from the heat sink bonding procedure. Additionally the inventors have found that AlGaAsP can be used as a means of compensating for other structural layers, for example a highly strained compressive quantum well.

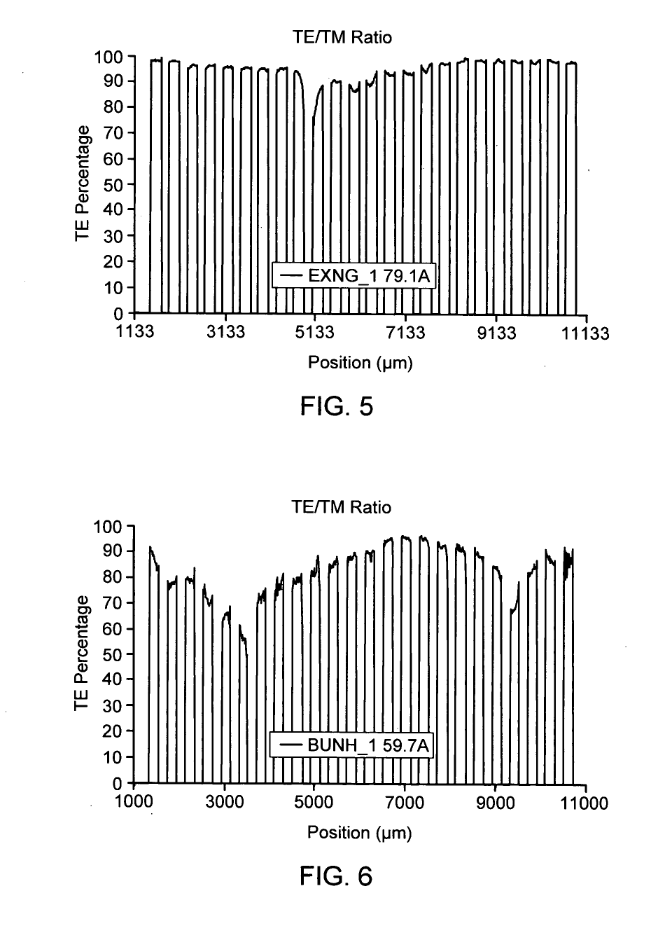

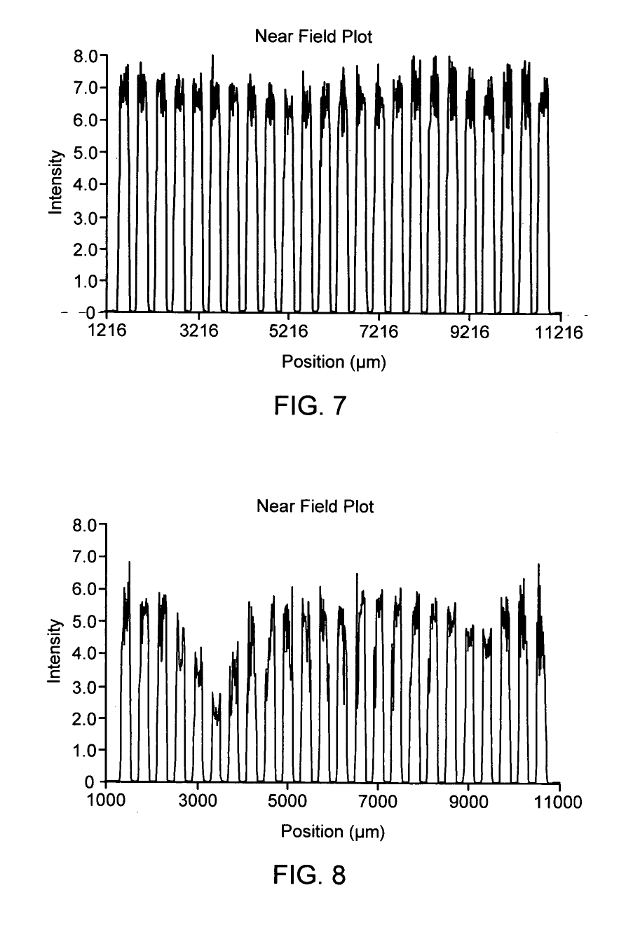

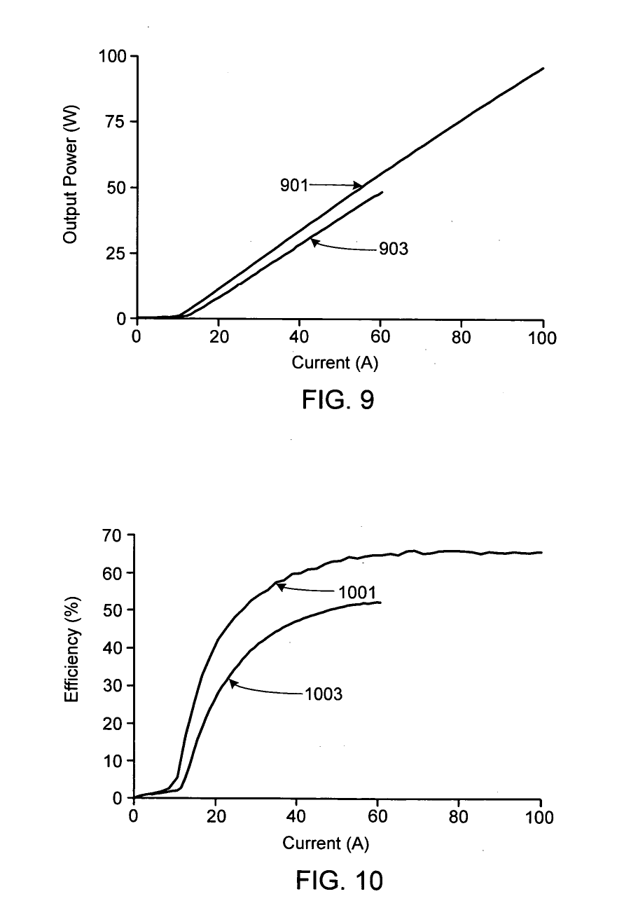

FIGS. 5-10 illustrate the benefits of the invention for a 1 centimeter diode laser bar bonded to a copper heat sink and designed to operate at approximately 980 nanometers. In particular, FIGS. 5 and 6 provide the polarization maps for diode laser bars using bulk layers of AlGaAsP and AlGaAs, respectively; FIGS. 7 and 8 provide the intensity maps for diode laser bars using bulk layers of AlGaAsP and AlGaAs, respectively; FIG. 9 illustrates the achievable output power for a diode laser bar using a bulk layer of AlGaAsP (line 901) versus the achievable output power for a diode laser bar using a bulk layer of AlGaAs (line 903); and FIG. 10 illustrates the efficiency curve for a diode laser bar using a bulk layer of AlGaAsP (line 1001) versus the efficiency curve for a diode laser bar using a bulk layer of AlGaAs (line 1003).

It will be appreciated that the invention lies in the use of one or more layers of AlGaAsP within a structure, preferably a laser diode structure, these layers being used to either achieve a lattice match with GaAs or to fabricate a tensile strained layer or structure, thus compensating for a compressively strained layer/structure or for the stress field imparted during heat sink bonding. Accordingly the invention is not limited to a specific structure, AlGaAsP compound, or deposition technique.

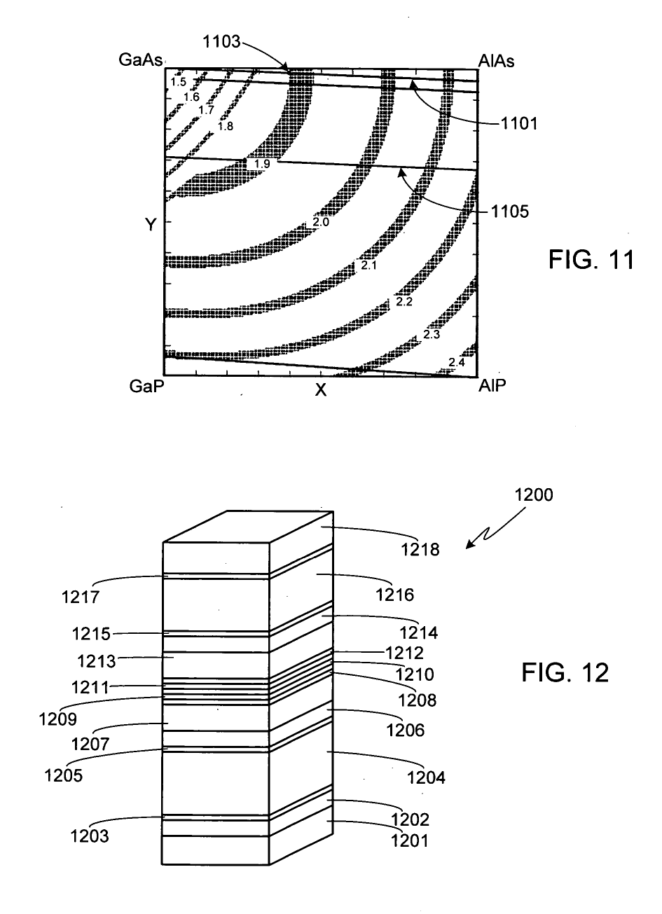

In general, the phase diagram for AlGaAsP (FIG. 11) can be used to determine optimal layer compositions. For example, in order to match the lattice constant for GaAs, the composition for the AlGaAsP layer will fall on line 1101. Accordingly for lattice matching the percentage of phosphorous in the layer will be less than 4 percent. An exemplary composition on line 1101 is Ga_{0.6}Al_{0.4}As_{0.985}P_{0.015} (data point 1103). By further increasing the percentage of phosphorous, the lattice mismatch between the AlGaAsP compound and GaAs will impart a tensile strain to the resultant structure. For example, compositions lying on line 1105 will have a 1 percent tensile strain, typically sufficient to compensate for a compressively strained layer or the stresses induced during heat sink bonding.

The material of the present invention, i.e., AlGaAsP, can be used to replace AlGaAs in any of a variety of structures in which it is desirable to control the stress within the layer, creating either stressless or tensile stressed structures. Furthermore it is possible to fabricate such layers/structures using any of a variety of techniques including metal organic chemical vapor phase epitaxy (MOCVD), molecular beam epitaxy (MBE), liquid phase epitaxy (LPE) and vapor phase epitaxy (VPE).

An exemplary laser diode structure 1200 utilizing the invention is shown in FIG. 12. It should be understood that this is only one type of diode laser, and only one structure of one type of diode laser, to which this invention is applicable. For example, the invention is applicable to broad area lasers, linear array lasers, single spatial mode lasers, single longitudinal mode lasers and surface emitting lasers.

Substrate 1201 is fabricated from n-type GaAs material. It will be appreciated that the invention is not limited to n-type GaAs. For example, similar structures can be fabricated using p-type or undoped GaAs. Furthermore the invention is not limited to a particular substrate orientation. After substrate 1201 is degassed and deoxided, a GaAs buffer layer 1202 is grown in order to recondition the surface of substrate 1201. The thickness of buffer layer 1202 is within the range of 0 to 20 microns and preferably within the range of 0.1 to 1 micron.

A transition layer 1203 is grown on top of buffer layer 1202. In the illustrated embodiment, transition layer 1203 is between 0.02 and 0.04 microns thick and comprised of Si-doped InGaAsP. The n-side cladding layer 1204 is preferably comprised of a Si-doped material such as InGaP, InGaAsP, AlGaAsP or AlInGaP, with a thickness within the range of 0 to 20 microns and a preferred thickness of approximately 1.5 microns. Cladding layer 1204 can utilize either a graded or constant doping level although a constant doping level of approximately 1×10¹⁸ cm⁻³ is preferred.

After the n-side cladding layer 1204, a Si-doped AlGaAsP transition layer 1205 is grown with a composition ramping from a value within the range of 40%-25% to a value within the range of 30%-5%, the selected upper/lower values for the range depending on the composition of the confinement layer. The thickness of transition layer 1205 is within the range of 0 to 1 micron with a preferred thickness of approximately 0.05 microns. Transition layer 1205 is doped at a level within the range of 2×10¹⁷ cm⁻³ to 1×10¹⁸ cm⁻³, and preferably doped at the same level as n-side cladding layer 1204.

The next layers in the structure are a pair of confinement layers 1206 and 1207, preferably both of which are comprised of AlGaAsP with an Al content matching that of the final value of transition layer 1205 (i.e., within the range of 30%-5%). The thickness of confinement layer 1206 is within the range of 0 to 1 microns with a preferred thickness within the range of 0 to 0.5 microns. If doped, preferably confinement layer 1206 is doped with Si to a level of less than 8×10¹⁷ cm⁻³. The thickness of confinement layer 1207 is within the range of 0 to 1 microns with a preferred thickness within the range of 0 to 0.5 microns. A graded index layer 1208 comprised of AlGaAsP is grown on top of layer 1207. The Al content in layer 1208 preferably ramps from the concentration of the confinement layers to a concentration within the range of 10%-2%. The thickness of graded index layer 1208 is within the range of 0 to 1 microns with a preferred thickness of approximately 0.05 microns.

Layers 1209-1211 represent the active region of the diode laser. Layers 1209 and 1211 (e.g., barrier layers) are comprised of GaAs, each having a thickness of approximately 50 angstroms. Layer 1210 is the quantum well layer comprised of InGaAs with a thickness of approximately 70 angstroms. The In content and the thickness of quantum well layer 1210 can be varied in order to achieve different wavelengths. Wavelength selection can also be achieved by adding various elements such as aluminum, antimony, nitrogen, phosphorus and other III-V elements to the quantum well layer.

Layer 1212 is the p-side graded index layer comprised of AlGaAsP. The Al content in layer 1212 ramps from the final value of graded index layer 1208 to a value within the range of 30% to 5%. The thickness of graded index layer 1212 is within the range of 0 to 1 microns with a preferred thickness of 0.05 microns.

Layers 1213 and 1214 are a pair of p-side confinement layers, both of which are comprised of AlGaAsP with a preferred Al content matching that of the final value of graded index layer 1212. The thickness of confinement layer 1213 is within the range of 0 to 1 microns with a preferred thickness within the range of 0 to 0.5 microns. The thickness of confinement layer 1214 is within the range of 0 to 1 microns with a preferred thickness within the range of 0 to 0.5 microns. If doped, preferably layer 1214 is doped with Zn to a level of less than 8×10¹⁷ cm⁻³.

Before growing the p-cladding layer 1216, a p-type doped transition layer 1215 is grown, layer 1215 comprised of AlGaAsP with an Al composition ramping from that of layer 1214 to that of layer 1216 (i.e., within the range of 40%-25%). The thickness of layer 1215 is within the range of 0 to 20 microns with a preferred thickness of approximately 0.05 microns. Transition layer 1215 is preferably doped with Zn to a level within the range of 1×10¹⁷ cm⁻³ to 1×10¹⁸ cm⁻³. Layer 1216 is preferably comprised of a Zn doped material such as InGaP, InGaAsP, AlInGaP, or AlGaAsP with a thickness within the range of 0 to 20 microns and a preferred thickness of approximately 1 micron. Layer 1216 is preferably doped with Zn to a level of approximately 5×10¹⁷ cm⁻³. A short transition layer 1217 comprised of Zn-doped AlGaAsP is grown to a thickness of 0.04 microns prior to growing a GaAs contact layer 1218. The dopant level of layer 1217 is preferably approximately 2×10¹⁸ cm⁻³ with an Al composition ramping from that of layer 1216 to within the range of 10% to 2%. Preferably contact layer 1218 is within the range of 0 to 1 micron thick and is doped with Zn to a level greater than 1×10¹⁸ cm⁻³.

Using epitaxial structure 1200, broad area lasers were fabricated by cleaving appropriately metallized wafers into 1 centimeter long bars and coating the front and rear facets with a partially reflective coating (e.g., 5%) and a highly reflective coating (e.g., 95%), respectively. The laser bars were soldered to copper heat sinks using indium solder and a reflow furnace. The soldering temperature was 140° C. and the copper heat sink was pre-deposited with gold.

It will be understood that the detailed device structure described above is an exemplary embodiment intended to simply demonstrate the benefits of the invention and is not intended to limit the scope of the invention to this particular structure. Once the benefits and the method of implementing the invention are understood, those of skill in the art will recognize that the invention can be implemented in other structures. In general terms, the inclusion of phosphorous in AlGaAs can be used to achieve a strainless, or purposely strained, multi-layer design. Layers of AlGaAsP can also be used to mitigate the compressive strain built into a structure due to layer material selection, metallization, surface dielectrics or polymers, or other processing steps. Additionally, and as previously noted, active layers of AlGaAsP can be used in a quantum well to achieve improved performance.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

What is claimed is:

1. A semiconductor diode laser comprising:
a GaAs substrate;
a first cladding layer formed on said GaAs substrate;
a first confinement layer formed on said first cladding layer;
a quantum well formed on said first confinement region;
a second confinement layer formed on said quantum well;
a second cladding layer formed on said second confinement layer;
a contact layer formed on said second cladding layer; and
wherein at least one of said first cladding layer, said first confinement layer, said second confinement layer, and said second cladding layer is comprised of AlGaAsP.

2. The semiconductor diode laser of claim 1, wherein a layer thickness corresponding to said at least one of said first cladding layer, said first confinement layer, said second confinement layer, and said second cladding layer comprised of AlGaAsP is at least 0.1 microns thick.

3. The semiconductor diode laser of claim 1, wherein said at least one of said first cladding layer, said first confinement layer, said second confinement layer, and said second cladding layer comprised of AlGaAsP is lattice matched to said GaAs substrate.

4. The semiconductor diode laser of claim 1, wherein said at least one of said first cladding layer, said first confinement layer, said second confinement layer, and said second cladding layer comprised of AlGaAsP is lattice mismatched with said GaAs substrate.

5. The semiconductor diode laser of claim 4, wherein said lattice mismatch generates a tensile stress within said semiconductor diode laser.

6. The semiconductor diode laser of claim 5, wherein said generated tensile stress compensates for stress imparted to said semiconductor diode laser by a heat sink bonding procedure.

7. The semiconductor diode laser of claim 4, wherein said lattice mismatch provides stress relief within said semiconductor diode laser.

8. The semiconductor diode laser of claim 1, further comprising a buffer layer interposed between said GaAs substrate and said first cladding layer.

9. The semiconductor diode laser of claim 8, further comprising a transition layer interposed between said buffer layer and said first cladding layer.

10. The semiconductor diode laser of claim 1, wherein said first cladding layer is an n-type cladding layer and said second cladding layer is a p-type cladding layer.

11. The semiconductor diode laser of claim 1, wherein said first cladding layer is a p-type cladding layer and said second cladding layer is an n-type cladding layer.

12. The semiconductor diode laser of claim 1, wherein said first cladding layer is selected from the group consisting of AlGaAsP, InGaP, AlGaInP and InGaAsP.

13. The semiconductor diode laser of claim 1, wherein said second cladding layer is selected from the group consisting of AlGaAsP, InGaP, AlGaInP and InGaAsP.

14. The semiconductor diode laser of claim 1, wherein said first cladding layer has a graded doping level.

15. The semiconductor diode laser of claim 1, wherein said first cladding layer has a constant doping level.

16. The semiconductor diode laser of claim 1, wherein said second cladding layer has a graded doping level.

17. The semiconductor diode laser of claim 1, wherein said second cladding layer has a constant doping level.

18. The semiconductor diode laser of claim 1, wherein said substrate is selected from the group consisting of n-type GaAs, p-type GaAs and undoped GaAs.

19. The semiconductor diode laser of claim 1, wherein said contact layer is comprised of GaAs.

20. The semiconductor diode laser of claim 1, wherein said quantum well is comprised of InGaAs.

21. The semiconductor diode laser of claim 1, further comprising a first barrier layer adjacent to a first side of said quantum well and a second barrier layer adjacent to a second side of said quantum well.

22. The semiconductor diode laser of claim 21, wherein said first barrier layer and said second barrier layer are comprised of GaAs.

23. The semiconductor diode laser of claim 1, further comprising a transition layer between said second cladding layer and said contact layer.

24. The semiconductor diode laser of claim 1, further comprising a transition layer between said second cladding layer and said second confinement layer.

25. The semiconductor diode laser of claim 1, further comprising a transition layer between said first cladding layer and said first confinement layer.

26. The semiconductor diode laser of claim 1, wherein said first confinement layer is comprised of multiple layers.

27. The semiconductor diode laser of claim 1, wherein said second confinement layer is comprised of multiple layers.

28. The semiconductor diode laser of claim 1, wherein said first confinement layer is comprised of at least one layer of AlGaAsP.

29. The semiconductor diode laser of claim 1, wherein said second confinement layer is comprised of at least one layer of AlGaAsP.

30. The semiconductor diode laser of claim 1, wherein said semiconductor diode laser is selected from the group consisting of broad area lasers, linear array lasers, single spatial mode lasers, single longitudinal mode lasers and surface emitting lasers.

31. The semiconductor diode laser of claim 1, wherein said semiconductor diode laser is grown using an epitaxial growth technique selected from the group consisting of metal organic chemical vapor phase epitaxy, molecular beam epitaxy, liquid phase epitaxy and vapor phase epitaxy.

32. A method of controlling stress within a semiconductor diode laser, the method comprising the steps of:
selecting GaAs as a substrate for said semiconductor diode laser;
growing a first cladding region on said GaAs substrate;
growing a first confinement region on said first cladding region;
growing a quantum well region on said first confinement region;
growing a second confinement region on said quantum well region;
growing a second cladding region on said second confinement region;
growing a contact region on said second cladding region; and
selecting at least one of said first cladding layer, said first confinement layer, said second confinement layer, and said second cladding layer to be comprised of AlGaAsP.

33. The method of claim 32, further comprising the step of selecting a layer thickness of at least 0.1 microns for said at least one of said first cladding layer, said first confinement layer, said second confinement layer, and said second cladding layer comprised of AlGaAsP.

34. The method of claim 32, further comprising the step of selecting a composition for said at least one of said first cladding layer, said first confinement layer, said second confinement layer, and said second cladding layer comprised of AlGaAsP that will generate a tensile stress within said semiconductor diode laser, wherein said tensile stress mitigates a compressive stress that results from the step of bonding said semiconductor diode laser to a heat sink.

35. The method of claim 32, further comprising the step of selecting a composition for said at least one of said first cladding layer, said first confinement layer, said second confinement layer, and said second cladding layer comprised of AlGaAsP that will generate a tensile stress, wherein said tensile stress mitigates a compressive stress within said semiconductor diode laser.

36. The method of claim 32, further comprising the step of selecting a composition for said at least one of said first cladding layer, said first confinement layer, said second confinement layer, and said second cladding layer comprised of AlGaAsP in which the phosphorous content is greater than 4%.

37. A method of controlling stress within a semiconductor diode laser, the method comprising the steps of:
selecting a substrate for said semiconductor diode laser;
growing a first cladding region on said substrate;
growing a first confinement region on said first cladding region;
growing a quantum well region on said first confinement region, said quantum well region comprising:
a quantum well;
a first barrier layer adjacent to a first side of said a quantum well;
a second barrier layer adjacent to a second side of said quantum well; and
selecting at least one of said first and second barrier layers to be comprised of GaAs; and
growing a second confinement region on said quantum well region;
growing a second cladding region on said second confinement region;
growing a contact region on said second cladding region; and
selecting at least one of said first and second confinement regions to be comprised of AlGaAsP, wherein said selected confinement region is adjacent to said barrier layer selected to be comprised of GaAs.
